(19) United States
(12) Patent Application Publication
(10) Pub. No.: US 2011/0242053 A1
(43) Pub. Date: Oct. 6, 2011

(54) OPTICAL TOUCH SCREEN DEVICE

(75) Inventor: CHI-WEI CHIU, Tu-Cheng (TW)

(73) Assignee: HON HAI PRECISION INDUSTRY CO., LTD., Tu-Cheng (TW)

(21) Appl. No.: 12/903,225

(22) Filed: Oct. 13, 2010

(30) Foreign Application Priority Data
Apr. 6, 2010 (TW) 99110486

(51) Int. Cl. G06F 3/042

(52) U.S. Cl. 345/175

(57) ABSTRACT

An optical touch screen device includes a display panel, a light source module, an image capture module, a sound detecting member, and a processing unit. The display panel includes a display screen. The light source module is configured for emitting light to illuminate an input device on the display screen. The image capture module is configured for capturing images of the illuminated input device, determining coordinates of a position of the input device on the display screen based on the images, and generating a first input signal associated with the coordinates of the input device. The sound detecting member is configured for detecting a stroke of the input device on the display screen, and generating a second input signal associated with the stroke of the input device. The processing unit is configured for generating a command signal based on the first input signal and the second input signal.

### BACKGROUND

1. Technical Field

The disclosure relates to optical touch screen devices, and particularly, to an optical touch screen device with a sound detection member.

2. Description of Related Art

A typical electronic information device is equipped with a number of mechanical keys, and a display device for displaying information such as characters, images, etc. The mechanical keys are used to input information and realize control function of the device. However, the mechanical keys are inconvenient to use, as electronic information devices become smaller.

Therefore, what is needed, is an optical touch screen device which can overcome the above shortcomings.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric view of an optical touch screen device in accordance with a first embodiment.

FIG. 2 is a schematic view of a sound detecting member of the device of FIG. 1.

FIG. 3 is an isometric view of an optical touch screen device in accordance with a second embodiment.

FIG. 4 is an isometric view of an optical touch screen device in accordance with a third embodiment.

FIG. 5 is an isometric view of an optical touch screen device in accordance with a fourth embodiment.

FIG. 6 is a partial and cross-sectional view of the optical touch screen device of FIG. 5, taken along line VI-VI.

### DETAILED DESCRIPTION

Embodiments of the optical touch screen device will now be described in detail below and with reference to the drawings.

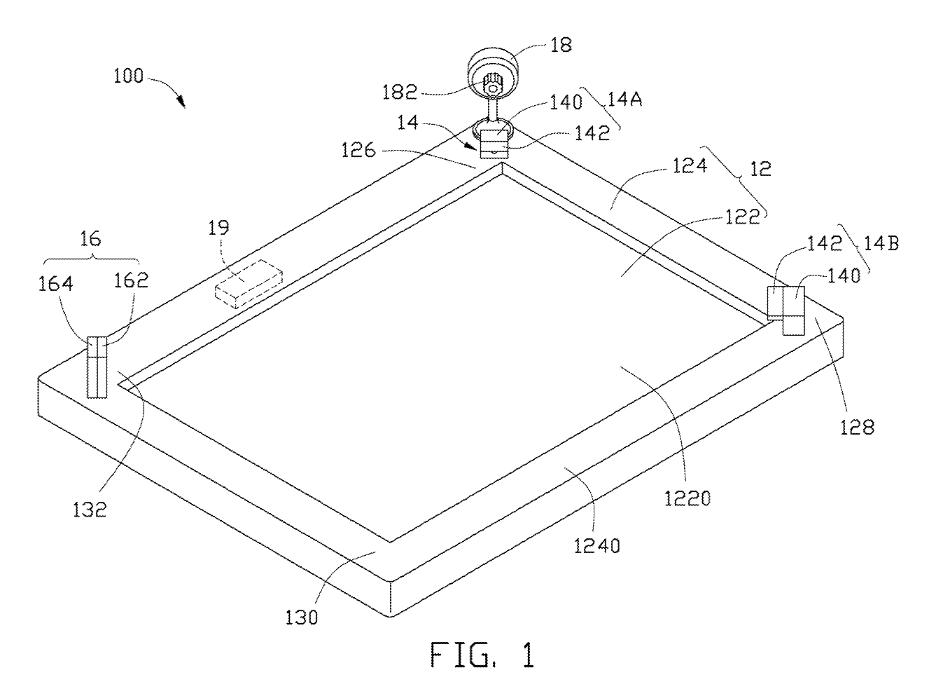

Referring to FIG. 1, an optical touch screen device 100 in accordance with a first embodiment includes a display panel 12, a light source module 14, a sound detecting member 16, an image capture module 18, and a processing unit 19.

The display panel 12 can be a liquid crystal display panel. Alternatively, the display panel 12 can be a field emission display panel, or a plasma display panel. The display panel 12 includes a rectangular display screen 122 and a securing frame 124. The securing frame 124 is arranged around the display screen 122. An edge portion of the securing frame 124 is inserted and secured in the securing frame 124. In this embodiment, the securing frame 124 includes a first corner 126, a second corner 128, a third corner 130, and a fourth corner 132. The first corner 126 and the third corner 130 are arranged diagonally opposite to each other. The second corner 128 and the fourth corner 132 are arranged diagonally opposite to each other.

The display screen 122 includes a display surface 1220 for displaying images. The securing frame 124 includes a mounting surface 1240 protruding from the display surface 1220.

In this embodiment, the light source module 14 includes a first light source device 14A and a second light source device 14B. The first and the second light source devices 14A, 14B are arranged on the mounting surface 1240 at the respective first and second corners 126, 128. Each of the first and the second light source devices 14A, 14B include an infrared point light source 140 and a light shielding plate 142. The infrared point light source 140 may for example be an infrared light emitting diode. In this embodiment, the infrared point light source 140 of the first light source module 14A emits light toward the third corner 130. The infrared point light source 140 of the second light source module 14B emits light toward the fourth corner 132. The light from the two infrared point light sources 140 cooperatively form an infrared light grid (or an infrared light pattern) over the display surface 1220. The two light shielding plates 142 are attached to the respective infrared point light sources 140. In this embodiment, the two light shielding plates 142 are configured for blocking light from the respective infrared point light sources 140 to the image capture module 18.

The image capture module 18 is mounted on the mounting surface 1240 of the securing frame 124. A field of view of the image capture module 18 covers the entire display surface 1220. The image capture module 18 can be arranged on the first corner 126 or the second corner 128. In this embodiment, the image capture module 18 is arranged on the first corner 126, and is located adjacent to the first light source module 14A. As shown in FIG. 1, the image capture module 18 includes a lens module 182 and may, for example, a photo detector (not shown). The lens module 182 is located above the light shielding plate 142 of the first light source module 14A, and is oriented toward the display surface 1220 for receiving light therefrom. The infrared light grid is located between the display screen 122 and the lens module 182. Alternatively, the image capture module 18 may be located at another suitable position of the display panel 12, as long as the field of view of the image capture module 18 covers the entire display screen 122.

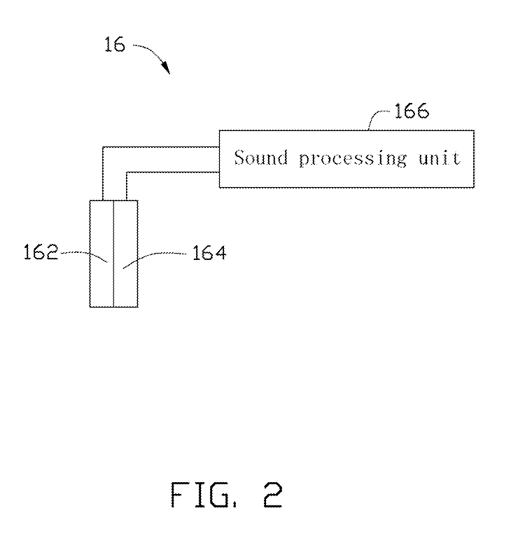

Referring to FIG. 1 and FIG. 2, in this embodiment, the sound detecting member 16 is arranged on the mounting surface 1240 at the fourth corner 132. In alternative embodiment, the sound detecting member 16 can be arranged on the third corner 130. The sound detecting member 16 includes a first sound detecting unit 162, a second sound detecting unit 164, and a sound processing unit 166. Each of the first and the second sound detecting units 162, 164 can be a microphone, such as a capacitor microphone or a moving-coil microphone, or another suitable microphone. In this embodiment, the first sound detecting unit 162 is near to the display panel 12, and the second sound detecting unit 164 is farther from the display panel 12. In addition, the first sound detecting unit 162 is oriented toward the display surface 1220. The second sound detecting unit 164 is oriented away from the display surface 1220. That is, the second sound detecting unit 164 is oriented toward an exterior of the display panel 12.

In operation, when a user touches the display surface 1220 with an input device or an object (such as a stylus or a finger) and thus generating a stroke of the input device or the object on the display screen 122, in a quiet exterior environment, the first sound detecting unit 162 and the second sound detecting unit 164 each may detect only the stroke. In a noisy exterior environment, the first sound detecting unit 162 and the second sound detecting unit 164 each may detect the stroke, as well as sound from exterior of the display screen 122 (generally referring to noise). In general, intensity of the stroke detected by the first sound detecting unit 162 is greater than the intensity of noise detected by the first sound detecting unit 162. In this embodiment, intensity of the stroke detected by the first sound detecting unit 162 is generally greater than intensity of the stroke detected by the second sound detecting unit 164, as the first sound detecting unit 162 is closer to the display screen 122 and the second sound detecting unit 164 is farther from the display screen 122. Conversely, the intensity of the noise detected by the first sound detecting unit 162 is generally smaller than that of the noise detected by the second sound detecting unit 164. Therefore, the first sound detecting unit 162 detects the stroke more precisely than that of the second sound detecting unit 162 detects.

In this embodiment, the first sound detecting unit 162 detects sound and generates a first detecting signal associated with the sound. The second sound detecting unit 164 detects sound and generates a second detecting signal associated with the sound. The sound processing unit 166 is electrically connected to the first and the second sound detecting units 162, 164 to receive the first and the second detecting signals. The sound processing unit 166 may, for example, include a digital signal processor (DSP) to processes the first and the second detecting signals.

In this embodiment, the processing unit 19 is electrically connected to the lens module 182 and the sound processing unit 166, and is secured in the securing frame 124.

The device 100 can be used to realize a touch control function. A process for realizing the touch control function is described as follows. Firstly, the field of view of the image capture module 18 is adjusted such that the entire display screen 122 is located in the field of view of the image capture module 18. Then a coordinate position of the display screen 122 in the field of view of the image capture module 18 can be calculated by a location processing unit (not shown) equipped in the image capture module 18. By using the location processing unit, coordinate positions of four points at four corresponding corners of the display screen 122 in the field of view of the image capture module 18 can be calculated. Thus, coordinate position of each point of the entire display screen 122 in the view field of the image capture module 18 can be calculated with respect to the above four coordinate positions. When an object (a finger or a stylus) moves toward and then touches the display screen 122, the object intercepts some light above the display screen 122 and causes a change in the infrared light grid. The object may for example reflect light of the infrared light grid to the image capture module 18. Thus a coordinate position of the object can be analyzed or calculated based on the change of the infrared light grid. The image capture module 18 thus generates a first input signal associated with the location of the object.

In one aspect, when the device 100 is operated in a quiet environment, each of the first and the second sound detecting units 162, 164 may detect only the stroke, and the sound processing unit 166 selects one of the first and the second detecting signals according to the intensities of the sound detected by the first or the second sound detecting units 162, 164. In this embodiment, the sound processing unit 166 processes the first detecting signal as intensely as that of the stroke detected by the first sound detecting unit 162 as greater than that of the sound detected by the second sound detecting unit 164. That is, the sound processing unit 166 responds to the first detecting signal to generate a second input signal associated with the stroke.

In another aspect, when the device 100 is operated in the noisy exterior environment, each of the first and the second sound detecting units 162, 164 may detect the stroke, as well as noise, and the sound processing unit 166 filters noisy signal before generating a second input signal. In this embodiment, as intensity of stroke detected by the first sound detecting unit 162 is greater than intensity of noise detected by the first sound detecting unit 162, thus noisy signal can be selected by comparing intensity of stroke and intensity of noise based on the first detecting signal. The noisy signal can be filtered by analyzing the property of the noisy signal detected by the second detecting unit 164, as the second detecting unit 164 detects the noisy signal more precisely than the first detecting unit 162 detects. Overall, the sound processing unit 166 generates a second input signal associated with strokes on the display screen 122 by analyzing the first and the second detection signals.

The processing unit 19 receives and analyzes the first and the second input signals to generate a command signal. In this embodiment, the command signal can be executed based on the coordinate position of the object, as well as times of stroke. In one example, the processing unit 19 may generate a command signal to a computer (equipped in the device 100 but not shown in FIG. 1 to FIG. 6) to select a file folder displayed by the display screen 122 if the user touches the display screen 122 for only one time. In another example, the processing unit 19 may generate another command signal to the computer to open the file folder if the user touches the display screen 122 for two times (in a short time).

One advantage of the device 100 is that the display screen 122 is used to display images, as well as realizing touch control function. Thus, the device 100 can be free of mechanical keys, and the device 100 is small in size. Another advantage of the device 100 is that the touch control function can be realized by detecting coordinate position of the object, as well as stroke. Thus, the device 100 is convenient for the user to control.

In alternative embodiments, the device 100 can be used as an electronic hand-written screen, and the device 100 can be used to detect movement track of the input device or the object on the display screen 122.

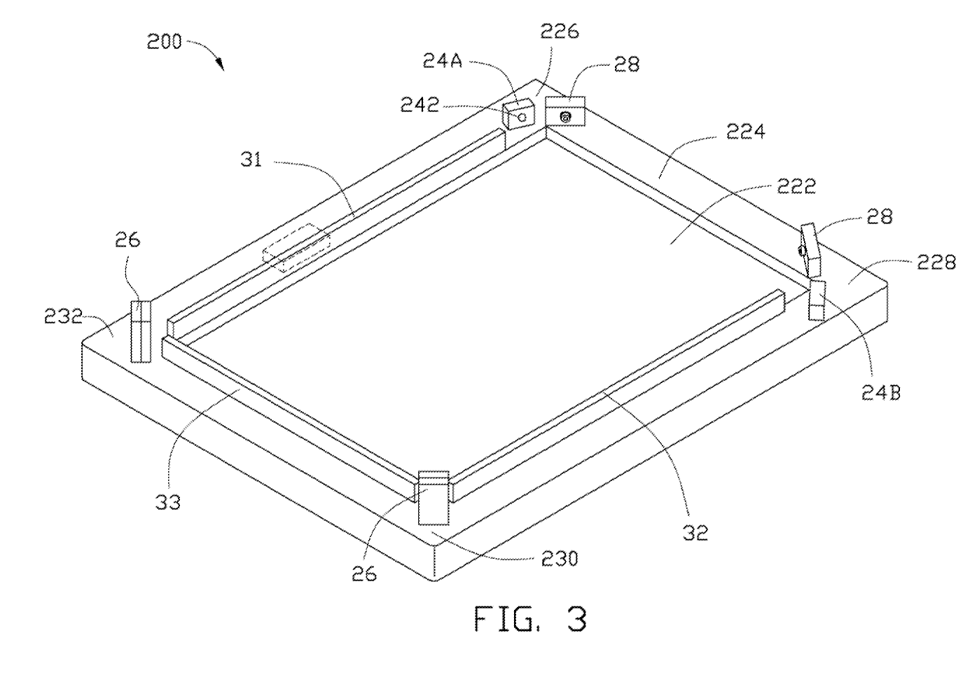

Referring to FIG. 3, an optical touch screen device 200 in accordance with a second embodiment is shown. The device 200 is similar to the device 100 of the first embodiment in principle and structure. However, for the device 200, two sound detecting members 16 are arranged on a securing frame 224. An image capture module (not labeled) includes two image capture devices 28. In addition, in this embodiment, the device 200 further includes a first reflective plate 31, a second reflective plate 32, and a third reflective plate 33.

The first, the second, and the third reflective plates 31, 32, and 33 are arranged on three respective edges of the securing frame 224. Each of the three reflective plates 31, 32, and 33 is substantially cuboid-shape, and is perpendicular to the corresponding side of the securing frame 224. In this embodiment, the first reflective plate 31 extends along an edge of the securing frame 224 between a first corner 226 and a fourth corner 232 of the securing frame 224. The second reflective plate 32 extends along an edge of the securing frame 224 between a second corner 228 and a third corner 230 of the securing frame 224. The third reflective plate 33 extends along an edge of the securing frame 224 between the third corner 230 and a fourth corner 232. The three reflective plates 31, 32, and 33 are configured for reflecting light from a first light source device 24A and a second light source device 24B, and thus securing a infrared light grid over a display screen 222. In this embodiment, each of the first light source device 24A and the second light source device 24B includes only an infrared point light source 240.

In this embodiment, one of the image capture device 28 is arranged at the first corner 226 adjacent to the first light source device 24A, and the other image capture device 28 is located at the second corner 228 adjacent to the second light source device 24B. Thus, the two image capture devices 28 are capable of picking up light reflected by the three reflective plates 31, 32, and 33.

In operation, when the object touches the display screen 222 and intersects the infrared light grid. Some light beams directed to the image capture devices 28 are intercepted by the object, and thereby forming a shadow. Then the shadow formed by the object is captured by the image capture device 28. The angle of the object's position with respect to the central axis of one image capture device 28 and the angle of the object's position with respect to the central axis of the other image capture device 28 can be analyzed or calculated. This angular information from the two image capture devices 28 defines a unique location of the object on the display screen 222. Thus, a command signal can be executed based on the location of the object, as well as times of the stroke.

In this embodiment, the display screen 222 can be relatively large, one of the sound detecting members 26 is arranged at the third corner 230, and the other sound detecting member 26 is located at the fourth corner 232. In operation, the stroke can be precisely detected by analyzing or comparing different detection results of the two sound detecting members 26.

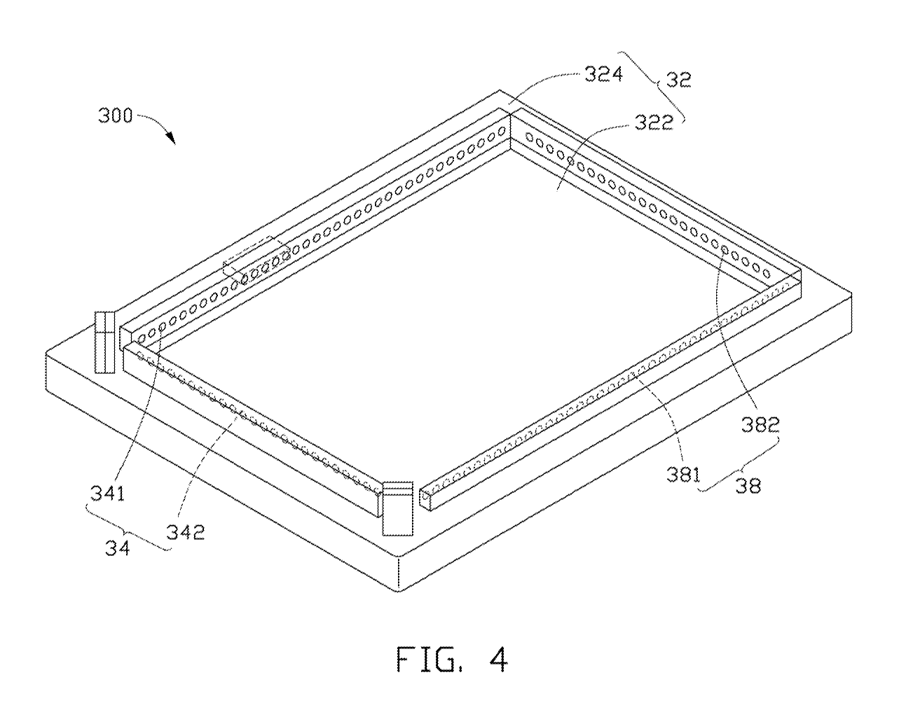

Referring to FIG. 4, an optical touch screen device 300 in accordance with a third embodiment is shown. The device 300 is similar to the device 200 of the second embodiment in structure. However, a light source module 34 includes a number of first direction IR emitters 341 and a number of second direction IR emitters 342. The infrared light capture module 38 includes a number of first direction infrared detectors 381 and a number of second direction infrared detectors 382.

As shown in FIG. 4, a display panel 32 of the device 300 includes a display screen 322 and a securing frame 324. Each of the first direction IR emitters 341, the first direction IR detectors 381, the second direction IR emitters 342, and the second direction IR detectors 382 are integrally connected to one another and arranged on the securing frame 324. The first direction IR emitters 341 and the first direction IR detectors 381 are disposed on opposite sides of the securing frame 324 and constitute a number of paired first direction IR emitter-detectors. The second direction IR emitters 342 and the second direction IR detectors 382 are disposed on another opposite sides of the securing frame 324 and constitute a number of paired second direction IR emitter-detectors.

In operation, the IR light emitted from the first direction and second direction IR emitters 341, 342 cooperatively form an IR light network. When the user touches the display screen 322 with the object to generate a touch point, the touch object will block the IR light emitted from at least one of the first direction IR emitters 341 and at least one of the second direction IR emitters 342. The first direction IR detector 381 and second direction IR detector 382 cooperatively detect the blocking of the IR light. Thus, a coordinate position of the object can be analyzed or calculated. In this embodiment, a command signal can also be executed based on the coordinate position of the object, as well as times of the stroke.

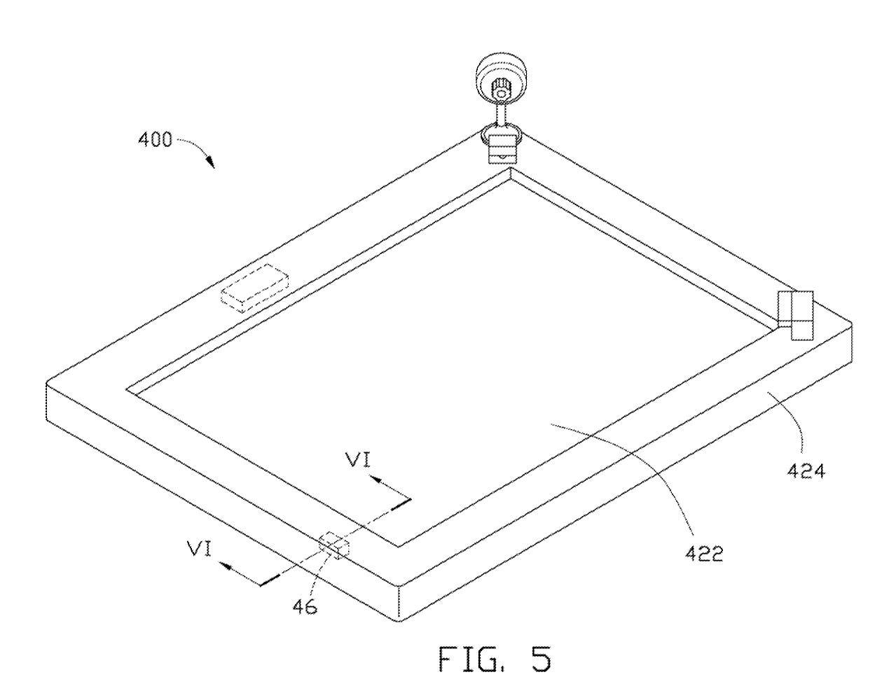

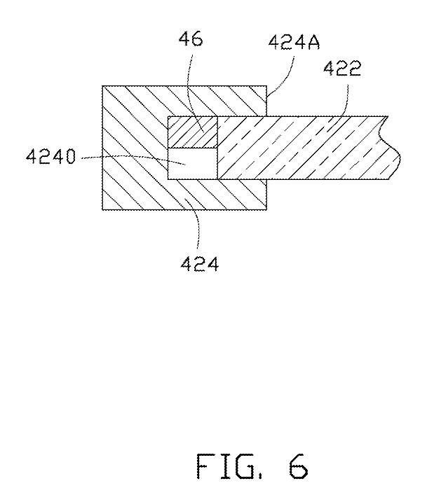

Referring to FIG. 5 and FIG. 6, an optical touch screen device 400 in accordance with a fourth embodiment is shown. The device 400 is similar to the device 100 of the first embodiment in principle. However, for the device 400, a sound detecting member 46 is secured in a securing frame 424. The sound detecting member 46 includes only a contact microphone, such as a piezoelectric microphone, and a processing unit (not shown).

As shown in FIG. 6, in this embodiment, a recess 4240 is defined in an inner side surface 424A of the securing frame 424 to receive the sound detecting member 46 and an edge portion of a display screen 422.

In operation, when the user touches the display screen 422 with the object to cause a vibration of the display screen 422 and the securing frame 424. The sound detecting member 46 detects the vibration of the securing frame 424. In this embodiment, a command signal can also be executed based on the coordinate position of the touch object, as well as times of the stroke.

One advantage of this embodiment is that noise from exterior of the display screen 422 can not affect detection of the sound detecting member 46, thus the sound detecting member 46 detect times of touch on the display screen 422 precisely.

It is understood that the above-described embodiments are intended to illustrate rather than limit the disclosure. Variations may be made to the embodiments without departing from the spirit of the disclosure. Accordingly, it is appropriate that the appended claims be construed broadly and in a manner consistent with the scope of the disclosure.

1. An optical touch screen device comprising:
a display panel comprising a display screen;
a light source module configured for emitting light to illuminate an input device on the display screen;
an image capture module configured for capturing images of the illuminated input device, determining coordinates of a position of the input device on the display screen based on the images, and generating a first input signal associated with the coordinates of the input device;
a sound detecting member configured for detecting a stroke of the input device on the display screen, and generating a second input signal associated with the stroke of the input device; and
a processing unit configured for generating a command signal based on the first input signal and the second input signal.

2. The optical touch screen device of claim 1, wherein the light source is configured to emit infrared light to illuminate the input device, and the image capture module is configured for capturing infrared images of the illuminated input device.

3. The optical touch screen device of claim 2, wherein the image capture module comprises a lens module facing the input device.

4. The optical touch screen device of claim 2, wherein the display panel comprises a securing frame surrounding the display screen, and the optical touch screen device further comprises a plurality of elongated reflective plates around the display screen, the infrared light capture module comprises two image capture devices arranged on a common edge of the securing frame.

5. The optical touch screen device of claim 1, wherein the sound detecting member comprises a first sound detecting unit, a second sound detecting unit, and a sound processing unit, each of the first sound detecting unit and the second sound detecting unit is selected from one of a capacitor microphone and a moving-coil microphone, and the first sound detecting unit is oriented toward the display screen to detect sound of the stroke, thereby generating a first detection signal associated therewith, the second sound detecting unit is oriented in a direction away from the display screen to detect sound of the stroke, thereby generating a second detection signal associated therewith, the sound processing unit is configured for filtering out noise and generating the second input signal based on the first and the second detection signals.

6. The optical touch screen device of claim 5, wherein the sound processing unit comprises a digital signal processor.

7. The optical touch screen device of claim 1, wherein the sound processing member comprises a piezoelectric microphone.

8. The optical touch screen device of claim 7, wherein the securing frame has a recess receiving the piezoelectric microphone.

9. The optical touch screen device of claim 1, wherein the light source module comprises a plurality of first direction infrared emitters oriented in a first direction and a plurality of second direction infrared emitters oriented in a second direction, the infrared light capture module comprises a plurality of first direction infrared detectors opposite to the respective first direction infrared emitters and a plurality of second direction infrared detectors opposite to the respective second direction infrared emitters, the first direction infrared emitters and the first direction infrared detectors being disposed on opposite sides of the display screen, the second direction infrared emitters and the second direction infrared detectors being disposed on the other opposite sides of the display screen.

10. The optical touch screen device of claim 1, wherein the light source module comprises at least one infrared light emitting diode.

11. An optical touch screen device comprising:
a display panel comprising a display screen;
a light source module configured for projecting an infrared light grid or an infrared light pattern over the display screen;
an infrared light capture module configured for capturing images of an input device entry in the infrared light grid or in the infrared light pattern, determining coordinates of a position of the input device based on the images, and generating a first input signal associated with the coordinates of the input device; and
a sound detecting member configured for detecting a stroke of the input device on the display screen, and generating a second input signal associated with the stroke of the input device.

12. The optical touch screen device of claim 11, wherein the sound processing member comprises a piezoelectric microphone.

13. The optical touch screen device of claim 12, further comprising a processing unit configured for analyzing the first input signal and the second input signal.

14. The optical touch screen device of claim 11, wherein the light source module comprises a plurality of first direction infrared emitters oriented in a first direction and a plurality of second direction infrared emitters oriented in a second direction, the infrared light capture module comprises a plurality of first direction infrared detectors opposite to the respective first direction infrared emitters and a plurality of second direction infrared detectors opposite to the respective second direction infrared emitters, the first direction infrared emitters and the first direction infrared detectors being disposed on opposite sides of the display screen, the second direction infrared emitters and the second direction infrared detectors being disposed on the other opposite sides of the display screen.

15. The optical touch screen device of claim 11, wherein the light source module comprises at least one infrared light emitting diode.

16. An optical touch screen device comprising:
a display panel comprising a display screen;
a light source module configured for emitting infrared light to form an infrared light grid or an infrared light pattern over the display screen;
an infrared light capture module configured for capturing images of an input device entry in the infrared light grid or in the infrared light pattern, determining a movement track of the input device based on the images, and generating a first input signal associated with the movement track of the input device;
a sound detecting member configured for detecting a stroke of the input device on the display screen, and generating a second input signal in response to the stroke of the input device; and
a processing unit configured for generate a command signal based on the first input signal and the second input signal.

17. The optical touch screen device of claim 16, wherein the infrared light capture module comprises a lens module facing the infrared light grid or the infrared light pattern.

18. The optical touch screen device of claim 17, wherein the display panel comprises a securing frame surrounding the display screen, and the optical touch screen device further comprises a plurality of elongated reflective plates around the display screen, the infrared light capture module comprises two image capture devices arranged on a common edge of the securing frame.

19. The optical touch screen device of claim 16, wherein the sound detecting member comprises a first sound detecting unit, a second sound detecting unit, and a sound processing unit, each of the first sound detecting unit and the second sound detecting unit is selected from one of a capacitor microphone and a moving-coil microphone, and the first sound detecting unit is oriented toward the display screen to detect sound of the stroke, thereby generating a first detection signal associated therewith, the second sound detecting unit is oriented in a direction away from the display screen to detect sound of the stroke, thereby generating a second detection signal associated therewith, the sound processing unit is configured for filtering out noise and generating the second input signal based on the first and the second detection signals.

19. The optical touch screen device of claim 18, wherein the sound processing unit comprises a digital signal processor.

20. The optical touch screen device of claim 16, wherein the light source module comprises a plurality of first direction infrared emitters oriented in a first direction and a plurality of second direction infrared emitters oriented in a second direction, the infrared light capture module comprises a plurality of first direction infrared detectors opposite to the respective first direction infrared emitters and a plurality of second direction infrared detectors opposite to the respective second direction infrared emitters, the first direction infrared emitters and the first direction infrared detectors being disposed on opposite sides of the display screen, the second direction infrared emitters and the second direction infrared detectors being disposed on the other opposite sides of the display screen.
